(19) United States
(12) Patent Application Publication
(10) Pub. No.: US 2014/0106950 A1
(43) Pub. Date: Apr. 17, 2014

(54) Method for Changing a Gear Cutting Tool with Double-Sided Bearing in a Gear Cutting Machine and Device Therefor

(71) Applicant: Liebherr-Verzahntechnik GmbH, Kempten (DE)

(72) Inventor: Thomas ZELLER, Kempten (DE)

(73) Assignee: Liebherr-Verzahntechnik GmbH, Kempten (DE)

(21) Appl. No.: 14/053,007

(22) Filed: Oct. 14, 2013

(30) Foreign Application Priority Data
Oct. 15, 2012 (DE) 10 2012 020 210.5

(51) Int. Cl. B23Q 3/155

(52) U.S. Cl. CPC B23Q 3/1554; B23Q 3/15513; B23Q 3/15526
USPC 483/1; 483/58; 483/13

(57) ABSTRACT

A method for changing a gear cutting tool with a double-sided bearing between a tool magazine and a machining head by way of a tool changer maintains a vertical alignment of the gear cutting tool along the vertical Z-axis. The method includes exchanging the gear cutting tool between the tool changer and the tool magazine or the machining head, moving the tool changer and the gear cutting tool between the machining head and the tool magazine or between the tool magazine and the machining head, and exchanging the gear cutting tool between the tool changer and the other of the tool magazine and the machining head while maintaining a vertical alignment of the tool throughout each exchanging and moving act or operation. A tool changer for carrying out the method mentioned is also described.

This application claims priority under 35 U.S.C. §119 to German Patent Application 10 2012 020 210.5, filed Oct. 15, 2012, the entire disclosure of which is incorporated herein by reference.

### BACKGROUND OF THE INVENTION

The present invention relates to a method for changing a gear cutting tool, and in particular a milling and grinding tool, with a double-sided bearing in a gear cutting machine, and a device for performing that method.

Methods and devices for changing tools in machining centers are known in the industry. Machining centers for metal-working processes, such as gear cutting, milling, or turning machines, can replaceably be equipped with a variety of tools or other auxiliaries. For the purpose of process optimization by automation, it is common practice to use special tool changers. The same represent a connecting element between a machining center and a tool magazine.

One function of a tool changer is to transport a tool required for a given working step in the machining center from the tool magazine to the machining center and, vice versa, to transport tools no longer required from the machining center to the tool magazine, so that a tool that is no longer required can be stored in the tool magazine.

By using such an automatic tool changer, the machining time of the workpiece can be reduced as compared to a manual tool changer. In addition, the tool changer takes over possibly monotonous, error prone and potentially dangerous work, which now no longer needs to be carried out by an operator.

Depending on the complexity of the tool, the tool bearing of the machining center, and the holding unit for the tool at the tool magazine, differently high requirements are to be met by the tool changer.

High requirements to be met by the tool changer here generally mean both increased acquisition costs and increased costs in ongoing operation. With increasing complexity of the tool changer, its susceptibility to malfunctions and the costs to remedy the same also are increasing.

### SUMMARY OF THE INVENTION

It is one object of the present invention to provide an improved method and an improved device for changing a gear cutting tool, which, here in particular, is a milling and grinding tool.

According to the invention, this object is solved by a method for changing a gear cutting tool with the features claimed.

It is advantageous when the alignment of the gear cutting tool during the tool changing operation is changed as little as possible, because, for changing the gear cutting tool between a tool magazine, a machining head, and a tool changer, a precise alignment or positioning within the corresponding tool holders generally is required. When the alignment or positioning of the gear cutting tool deviates from the admissible value, it is possible that a correct changing operation cannot be performed, as for example the gear cutting tool cannot be grasped correctly by the tool holder of the machining head or slips. The less the alignment of the gear cutting tool is changed during the changing operation, the smaller the risk of a false alignment of the gear cutting tool, in particular when the change positions of the gear cutting tool are identical during the changes of the gear cutting tool between tool magazine, machining head, and tool changer.

In principle, a gear cutting tool can be moved in 6 directions during a change operation according to its 6 degrees of freedom in dependence on the construction of the tool changer. Correspondingly, operation-related deviations between set and actual values of the movement of the gear cutting tool can be obtained in all 6 directions of movement, which render a correct change operation impossible. The restriction of the degrees of freedom underlying the invention reduces the risk of such deviations.

The vertical alignment of the gear cutting tool during the entire change operation is tantamount to the alignment of the tool along the Z-axis, which corresponds to the direction of the gravitational force, and at the same time is tantamount to the elimination of the rotary degrees of freedom around the X- and Y-axes. This alignment of the gear cutting tool leads to the fact that the center of gravity of the gear cutting tool is located at a rather short horizontal distance from the holding region of the gear cutting tool, at which the gear cutting tool is held by the gripper. By such a mounting of the gear cutting tool in the gripper, a minimization of the torque is achieved, which otherwise is exerted on the gripper by the gear cutting tool due to the gravitational force and the distance between holding region and center of gravity of the gear cutting tool. With a corresponding positioning it is easily possible to keep the torque acting on the gripper close to or at zero.

According to the invention, the method serves for transporting the gear cutting tool from a first device to a second device. In a preferred embodiment, the first device can be a tool magazine and the second device can be a machining head. In a further preferred exemplary embodiment, the first device can be a machining head and the second device can be a tool magazine.

In principle, the present invention is applicable in all kinds of machining centers and tools. However, an application in the field of gear cutting machines and the associated gear cutting tools can be effected particularly advantageously, since the large torques which are introduced into the device by the existing large gear cutting tool weights can be minimized according to the invention. In principle, a wide variety of tools can be used for carrying out the invention, and according to the invention, milling and grinding tools are meant here.

Furthermore, an embodiment is conceivable in which the machining head directly hands over the gear cutting tool to the tool magazine, without a tool changer separate from the gear cutting machine being provided for this purpose.

Various mechanisms are conceivable, which can be used when changing the gear cutting tool between the machining head and the tool changer and which provide for a safe and releasable connection of the gear cutting tool with the machining head. It must merely be ensured that the gear cutting tool automatically can be connected with the machining head such that machining of a workpiece is possible.

For connecting the gear cutting tool with or for releasing the gear cutting tool from the machining head it therefore is particularly advantageous that changing the gear cutting tool between the machining head and the tool changer comprises moving a tool main bearing and/or a tool counter bearing and/or a tool clamp.

Inversely, on the side of the tool magazine the gear cutting tool is connected with or released from the magazine. In general, different types of magazine can be used for carrying out the method according to the invention. Both the known disk magazines and chain magazines are conceivable when carrying out the invention. Deposit magazines also are imaginable, in which the gear cutting tools merely are deposited without being grasped by an active holding device. It merely is decisive that during a tool change between magazine and tool changer a vertical alignment of the tool is given.

In one embodiment, the method comprises a tool magazine in which the gear cutting tools are stored in a vertically hanging manner. The gear cutting tools can be connected with the tool magazine in different ways. Clamping connections, plug connections, magnetic connections or other means which are suitable to releasably connect the gear cutting tool with the tool magazine are conceivable. In an advantageous embodiment, at least one holding unit for holding the gear cutting tool is provided such that changing the gear cutting tool between the tool magazine and the tool changer comprises moving the holding unit for the gear cutting tool downwards and upwards in the tool magazine.

Furthermore, different further steps are conceivable, which can be effected in connection with the transport of the gear cutting tool from one device to the other device. These can be steps in which for example measurements are made at the gear cutting tool or the workpiece, or steps can be taken for the permanent removal of worn or damaged gear cutting tools, for inserting new gear cutting tools, or cleaning steps at the used gear cutting tool or the tool changer, the tool magazine or the machining head.

In metal working, and particularly in the above-mentioned machining technologies, such as milling and turning, considerable amounts of chips and cooling liquid can be obtained. It is common practice, therefore, to perform cleaning processes during the operation of the gear cutting machine. The cleaning processes can concern the gear cutting machine, but also the gear cutting tools, so that it can be provided to perform a cleaning operation between the removal or insertion and the transport of the gear cutting tool. Especially, it can be provided that the change of the gear cutting tool between the tool magazine and the tool changer comprises moving a carriage unit with gripper in direction of a cleaning position, moving a cleaning unit from a starting position into a cleaning position, performing of a cleaning of the gear cutting tool, and moving the cleaning unit from the cleaning position into the starting position.

Preferably, between the steps of the tool change between machining head and tool changer and the tool change between tool changer and tool magazine, a cleaning of the gear cutting tool is carried out in a cleaning position.

The invention furthermore relates to a tool changer which is formed for carrying out a method as claimed. The tool changer comprises at least a gripper and a carriage unit with an upper carriage, a middle carriage, and a lower carriage. The gripper is arranged at the upper carriage, the upper carriage can be moved by the middle carriage, and the upper and middle carriages can be moved by the lower carriage along a guide rail. The middle carriage also can be omitted; the lower carriage then additionally performs the function of the middle carriage.

Further details and advantages of the invention will be explained in detail with reference to an exemplary embodiment illustrated in the drawings.

### BRIEF DESCRIPTION OF THE DRAWINGS

FIG. 1 shows a tool changer with tool magazine and milling tools.

FIG. 2 shows a gear cutting machine.

FIG. 3 shows an arrangement of tool changer, tool magazine, gear cutting machine, and milling tools.

### DETAILED DESCRIPTION OF THE INVENTION

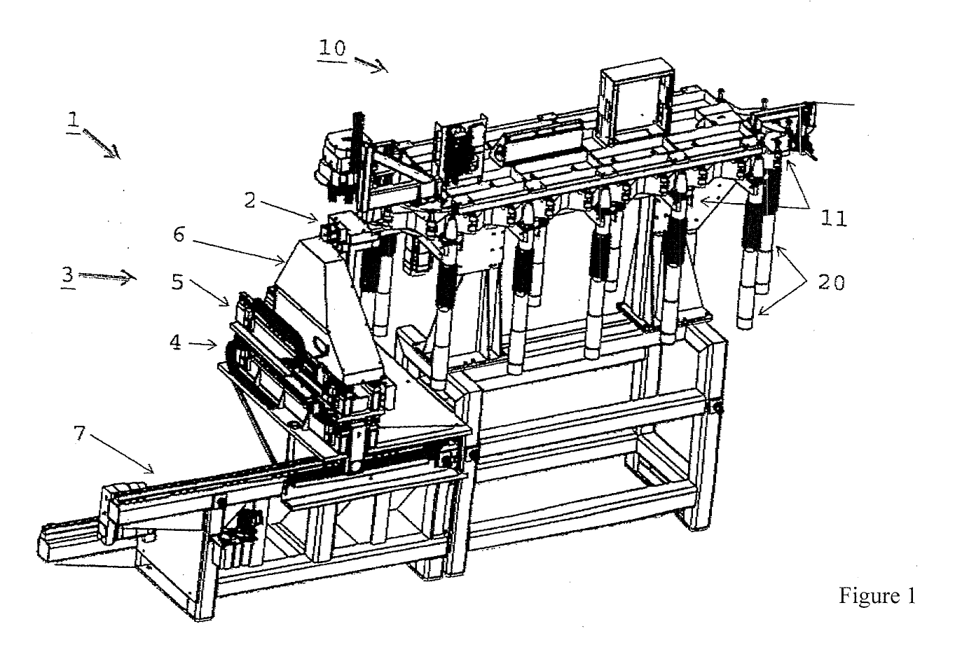

FIG. 1 shows an arrangement of a tool changer 1 and a tool magazine 10. The tool changer 1 comprises a gripper 2 and a carriage unit 3 which consists of an upper carriage 6, a middle carriage 5 and a lower carriage 4. The gripper 2 is arranged at the upper carriage 6. The carriage unit 3 together with the gripper 2 is arranged to be movable along a guide rail 7.

The tool magazine 10 comprises at least one holding unit 11, which is movable upwards and downwards and in which the milling tools 20 can be mounted.

In FIG. 1, the tool changer 1 is in a position in the region of the tool magazine 10, in which a milling tool 20 can be changed between the tool magazine 10 and the tool changer 1.

As shown in FIG. 1, the milling tools 20 are mounted in a vertical alignment. The change situation as shown in FIG. 1 between tool changer 1 and tool magazine 10 clearly illustrates that even in the moment of change, in which both the gripper 2 and the holding unit 11 are in contact with the milling tool 20, a vertical alignment of the milling tool 20 exists.

It is also apparent from FIG. 1 that chiefly vertically acting forces and no torques are introduced both into the holding unit 11 and into the gripper 2 by the weight of the milling tool 20.

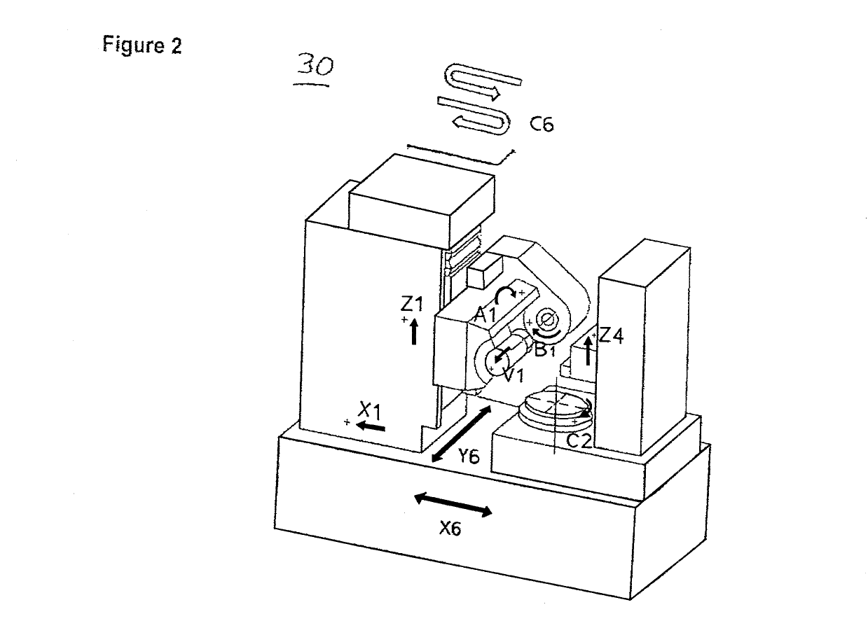

FIG. 2 shows a gear cutting machine 30 with the space axes X, Y and Z and the corresponding directions of rotation A, B and C.

Al relates to a swivel direction of a machining head, B1 indicates the tool axis, which corresponds to the axis of rotation of the main drive. V1 indicates the tangential displacement, X1 the radial axis, and Z1 the axial axis of the machining head. C2 is the workpiece axis, Z4 indicates the axis of movement of the counter bracket arm movement, C6 is an axis of rotation of a tool magazine with chain drive, Y6 is a translational axis of movement of the middle carriage 5 and the upper carriage 6, and X6 is a translational axis of movement of the complete carriage unit 3.

The gear cutting machine 30 is provided with means for mounting milling tools 20. The same for example can be formed as tool main bearing and tool counter bearing. The tool main bearing and the tool counter bearing can be arranged on separate axles. The tool counter bearing can be designed such that it is extendable for tool change. For the safe connection of milling tools 20 with the gear cutting machine 30, a tool clamp furthermore can be provided.

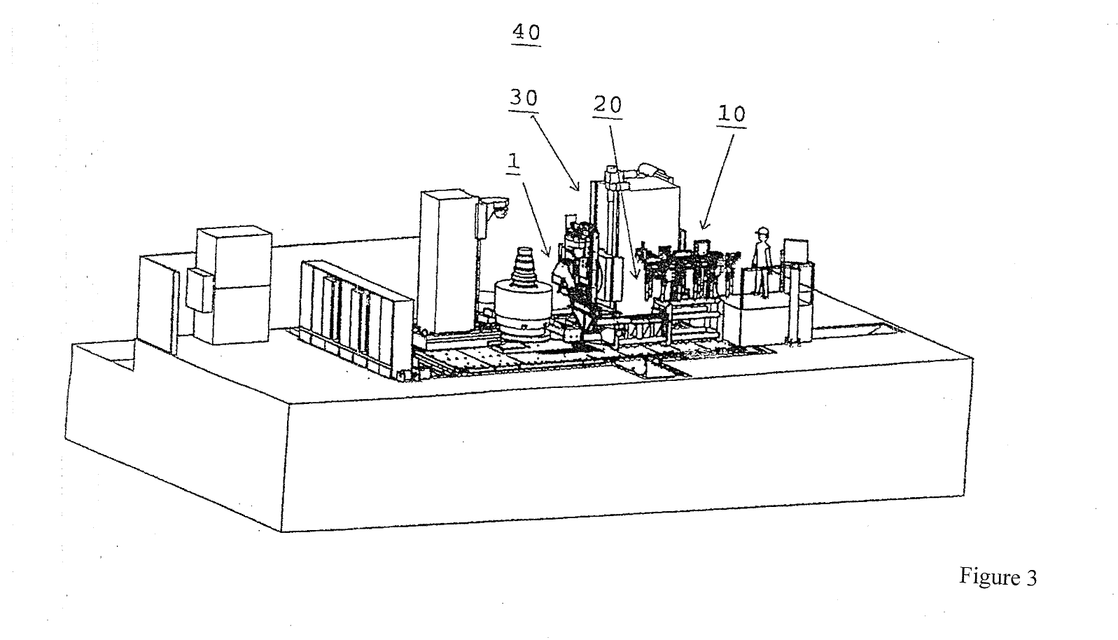

FIG. 3 shows an overall arrangement 40 of the tool changer 1, the tool magazine 10 and the machining head 30. In this representation, the tool changer 1 is located in the region of the machining head 30.

The tool changer 1 is in a position in which a milling tool 20 can be changed between the tool changer 1 and the machining head 30. The machining head 30 is in a tool change position, in which the milling tool 20 can be changed in a vertical alignment.

In the exemplary embodiment according to FIG. 1, the tool changer 1 is equipped with a single gripper 2. In accordance with the invention, however, a gripping device with two grippers can be provided at the upper carriage 6 in a manner not shown here. With a tool changer 1 modified in this way, a gear cutting tool provided for machining can be taken up and transported to the machining head. At the machining head, the used gear cutting tool can be taken up from the tool changer 1. By a corresponding rotary/shifting movement, the dual gripper arranged at the tool changer 1 can be pivoted, so that the gripper carrying the new gear cutting tool clamps the same in the machining head. After clamping the new gear cutting tool, the used gear cutting tool, which first has been taken up, can be transported back to the tool magazine 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for changing a gear cutting tool with a double-sided bearing between a tool magazine and a machining head by way of a tool changer while maintaining a vertical alignment of the gear cutting tool along a vertical Z-axis, comprising:
exchanging the gear cutting tool between the tool changer and one of the tool magazine and the machining head while maintaining the vertical alignment of the gear cutting tool,
moving the tool changer and the gear cutting tool between the machining head and the tool magazine or between the tool magazine and the machining head while maintaining the vertical alignment of the gear cutting tool, and
exchanging the gear cutting tool between the tool changer and the other of the tool magazine and the machining head while maintaining the vertical alignment of the tool.

2. The method according to claim 1, wherein exchanging the gear cutting tool between the machining head and the tool changer comprises moving at least one of a tool main bearing, a tool counter bearing, and a tool clamp.

3. The method according to claim 1, wherein exchanging the gear cutting tool between the tool magazine and the tool changer comprises moving a holding unit for the gear cutting tool downwards and upwards in the tool magazine.

4. The method according to claim 1, further comprising performing cleaning of the gear cutting tool in a cleaning position between removal or insertion and transport of the gear cutting tool.

5. The method according to claim 2, wherein exchanging the gear cutting tool between the tool magazine and the tool changer comprises moving a holding unit for the gear cutting tool downwards and upwards in the tool magazine.

6. The method according to claim 2, further comprising performing cleaning of the gear cutting tool in a cleaning position between removal or insertion and transport of the gear cutting tool.

7. The method according to claim 3, further comprising performing cleaning of the gear cutting tool in a cleaning position between removal or insertion and transport of the gear cutting tool.

8. The method according to claim 4, further comprising performing cleaning of the gear cutting tool in a cleaning position between removal or insertion and transport of the gear cutting tool.

9. A tool changer for changing a gear cutting tool with a double-sided bearing between a tool magazine and a machining head by way of a tool changer while maintaining a vertical alignment of the gear cutting tool along a vertical Z-axis, by exchanging the gear cutting tool between the tool changer and one of the tool magazine and the machining head while maintaining the vertical alignment of the gear cutting tool, moving the tool changer and the gear cutting tool between the machining head and the tool magazine or between the tool magazine and the machining head while maintaining the vertical alignment of the gear cutting tool, and exchanging the gear cutting tool between the tool changer and the other of the tool magazine and the machining head while maintaining the vertical alignment of the tool, the tool changer comprising:
a gripper, and
a carriage unit with an upper carriage, a middle carriage, and a lower carriage,
wherein the gripper is arranged at the upper carriage,
wherein the upper carriage is movable by the middle carriage, and
wherein the upper carriage and the middle carriage are movable along a guide rail by the lower carriage.

10. The tool changer according to claim 9, wherein the gear cutting tool between the machining head and the tool changer comprises at least one of a movable tool main bearing, a tool counter bearing, and a tool clamp.

11. The tool changer according to claim 9, further comprising a holding unit for the gear cutting tool that is movable downwards and upwards in the tool magazine when exchanging the gear cutting tool between the tool magazine and the tool changer.

12. The tool changer according to claim 9, further comprising a cleaning unit to perform cleaning of the gear cutting tool in a cleaning position between removal or insertion and transport of the gear cutting tool.

13. A tool changer for changing a gear cutting tool with a double-sided bearing between a tool magazine and a machining head by way of a tool changer while maintaining a vertical alignment of the gear cutting tool along a vertical Z-axis, by exchanging the gear cutting tool between the tool changer and one of the tool magazine and the machining head while maintaining the vertical alignment of the gear cutting tool, moving the tool changer and the gear cutting tool between the machining head and the tool magazine or between the tool magazine and the machining head while maintaining the vertical alignment of the gear cutting tool, and exchanging the gear cutting tool between the tool changer and the other of the tool magazine and the machining head while maintaining the vertical alignment of the tool, the tool changer comprising:
a gripper, and
a carriage unit with an upper carriage and a lower carriage,
wherein the gripper is arranged at the upper carriage,
wherein the upper carriage is movable by the lower carriage, and
wherein the upper carriage and the lower carriage are movable along a guide rail.

14. The tool changer according to claim 13, wherein the gear cutting tool between the machining head and the tool changer comprises at least one of a movable tool main bearing, a tool counter bearing, and a tool clamp.

15. The tool changer according to claim 13, further comprising a holding unit for the gear cutting tool that is movable downwards and upwards in the tool magazine when exchanging the gear cutting tool between the tool magazine and the tool changer.

16. The tool changer according to claim 13, further comprising a cleaning unit to perform cleaning of the gear cutting tool in a cleaning position between removal or insertion and transport of the gear cutting tool.
